(19) United States
(12) Patent Application Publication
(10) Pub. No.: US 2026/0268733 A1
(43) Pub. Date: Sep. 10, 2026

(54) TICKET VOUCHER FOR TRACKING GAMING DEVICE ACTIVITIES ASSOCIATED WITH A USER

(71) Applicant: IGT, Las Vegas, NV (US)

(72) Inventors: Jeffery Shepherd, Reno, NV (US); Kevin Higgins, Reno, NV (US)

(21) Appl. No.: 19/075,373

(22) Filed: Mar. 10, 2025

(51) Int. Cl. G07F 17/32; G06Q 50/34

(52) U.S. Cl. CPC G07F 17/3239; G06Q 50/34; G07F 17/3255

(57) ABSTRACT

Systems and methods that, following an occurrence of a tracking ticket voucher creation event at a first electronic gaming machine, receive, from a component of a gaming establishment management system, data associated with a gaming establishment account associated with an at least partially identified user, create, in a ticket voucher database, an association between ticket voucher data and the gaming establishment account, and cause a ticket voucher associated with the ticket voucher data to be issued.

### BACKGROUND

In various embodiments, following an occurrence of a tracking ticket voucher creation event at a first electronic gaming machine, the systems and methods of the present disclosure receive, from a component of a gaming establishment management system, data associated with a gaming establishment account associated with an at least partially identified user, create, in a ticket voucher database, an association between ticket voucher data and the gaming establishment account, and cause a ticket voucher associated with the ticket voucher data to be issued.

Developing and maintaining a loyal customer base is one component of operating a successful gaming establishment. To develop a loyal customer base, gaming establishments, such as casinos, attempt to generate interactions with their patrons that provide a unique and personalized experience. As an example, gaming establishments offer patrons the opportunity to participate in a player loyalty program via which patrons are offered various promotions that encourage the patron to return to the gaming establishment.

### BRIEF DESCRIPTION OF SEVERAL VIEWS OF THE DRAWINGS

FIG. 1 is an example configuration of the architecture of a plurality of different components of the system of one embodiment of the present disclosure which enable a ticket voucher to be employed as a user identifier.

FIG. 2 is a schematic diagram of the interactions between different components associated with an electronic gaming machine, a ticket voucher system and a gaming establishment patron management system to issue a ticket voucher employable as a user identifier.

FIG. 3 is a schematic diagram of the interactions between different components associated with an electronic gaming machine, a ticket voucher system and a gaming establishment patron management system in association with redeeming a ticket voucher employable as a user identifier.

### DETAILED DESCRIPTION

In various embodiments, following an occurrence of a tracking ticket voucher creation event at a first electronic gaming machine, the systems and methods of the present disclosure receive, from a component of a gaming establishment management system, data associated with a gaming establishment account associated with an at least partially identified user, create, in a ticket voucher database, an association between ticket voucher data and the gaming establishment account, and cause a ticket voucher associated with the ticket voucher data to be issued.

In various embodiments, in addition to enabling a ticket voucher to operate as an anonymous bearer instrument associated with an amount of funds and redeemable for cash via a kiosk, a cashier and/or game play on a gaming device, the system enables the ticket voucher to operate as a user identifier, such as a player tracking card. In these embodiments, a ticket voucher system that manages ticket vouchers operates with a gaming establishment patron management system, such as a player tracking system, to cause a ticket voucher issued by the ticket voucher system to be associated with certain user identifying information, such as a player tracking account number of a user. Such an association enables activity occurring at a gaming device, such as an electronic gaming machine (“EGM”), to be attributable to that user in situations when that user does not otherwise have access to a gaming establishment issued user identifier. For example, in cases when a player at an EGM does not have their player tracking card available because it is lost, stolen or not yet provided by the gaming establishment, the system utilizes a ticket voucher maintained by a ticket voucher system to function as the player tracking card to ensure that gaming activities of the player at the EGM are tracked and the player tracking system accrues loyalty benefits associated with the player based on such tracked gaming activities. In this example, the system further enables the ticket voucher functioning as the player tracking card to be subsequently used at another EGM to ensure that as the player engages multiple EGMs of one or more gaming establishments, the gaming activities of that player are tracked and the player tracking system accrues loyalty benefits associated with the player based on such tracked gaming activities.

In operation of certain embodiments, following a tracking ticket voucher creation event, such as a user at an EGM requesting the creation of a gaming establishment patron management system account and inputting certain identifying user data, the gaming establishment patron management system creates an account associated with a user. In operation of certain other embodiments, following a tracking ticket voucher creation event, such as a user at an EGM inputting certain identifying user data to log into an existing gaming establishment patron management system account, the gaming establishment patron management system accesses the existing account associated with the user. In these embodiments, following the creation or access of a gaming establishment patron management system account associated with a user, the ticket voucher system and the gaming establishment patron management system interface with each other to create a tracking ticket voucher associated with the created or accessed account. For example, following a user at an EGM accessing, without any player tracking card, a player tracking system account from the EGM, the ticket voucher system operates with the player tracking system to create a tracking ticket voucher associated with the user's player tracking system account. In this example, the ticket voucher system then operates with the EGM to cause a printer of the EGM to print the tracking ticket voucher. In these embodiments, the created tracking ticket voucher is compatible with the ticket voucher system but distinguishable from cashless ticket vouchers of the ticket voucher system in that the tracking ticket voucher is associated with an account of an identified user and not any amount of funds.

In certain embodiments, following the creation of a tracking ticket voucher, the system enables a redemption of the tracking ticket voucher at an EGM (which may be the same EGM associated with the creation of the tracking ticket voucher or another EGM). In these embodiments, once redeemed, the tracking ticket voucher operates as an identifier of the gaming establishment patron management system account to enable activity occurring at the EGM to be associated with the user. That is, following the redemption of the tracking ticket voucher at an EGM, the EGM (or a component of the gaming establishment management system associated with the EGM, such as a slot machine interface board (“SMIB”) associated with the EGM) operates with the ticket voucher system to determine if the redeemed ticket voucher is a cashless ticket voucher associated with an amount of funds or a tracking ticket voucher associated with an account of the gaming establishment patron management system. In certain embodiments, the system determines if the redeemed ticket voucher is a cashless ticket voucher or a tracking ticket voucher based on part of the ticket voucher number associated with the ticket voucher (e.g., ticket voucher numbers that begin with “00” are cashless ticket vouchers while ticket voucher numbers that begin with “11” are tracking ticket vouchers). In certain embodiments, the system additionally or alternatively determines if the redeemed ticket voucher is a cashless ticket voucher or a tracking ticket voucher based on an amount of funds, if any, associated with the ticket voucher (e.g., ticket vouchers associated with $0.00 are tracking ticket vouchers while ticket vouchers associated with more than $0.00 are cashless ticket vouchers). In certain embodiments, the system additionally or alternatively determines if the redeemed ticket voucher is a cashless ticket voucher or a tracking ticket voucher based on a ticket voucher state (e.g., ticket vouchers associated with a “User ID” state are tracking ticket vouchers).

If the ticket voucher system determines that the redeemed ticket voucher is a cashless ticket voucher associated with an amount of funds, the ticket voucher system enables the user to redeem the cashless ticket voucher for the amount of funds (which are added to the credit meter of the EGM). The EGM, and specifically the bill validator of the EGM, then stacks the redeemed cashless ticket voucher in the ticket voucher receptacle (e.g., the cashbox) of the EGM for subsequent accounting reconciliation. On the other hand, if the ticket voucher system determines that the redeemed ticket voucher is a tracking ticket voucher, the ticket voucher system interfaces with the gaming establishment patron management system to determine the account of the gaming establishment patron management system associated with the redeemed ticket voucher (which is associated with the EGM for the ensuing gaming session at the EGM to enable the user to earn zero, one or more loyalty benefits in association with the gaming session). In these embodiments, since the redeemed tracking ticket voucher is reusable at the same EGM (or a different EGM) at a later point in time, the EGM, and specifically the bill validator of the EGM, does not stack the redeemed tracking ticket voucher in any ticket voucher receptacle of the EGM, but rather returns (prior to, during or after the ensuing tracked gaming session at the EGM) the tracking ticket voucher to the user for reuse.

Accordingly, in certain instances in which a user arrives cardless at a gaming establishment (e.g., without being associated with any player tracking card or without any previously issued player tracking card on their person), one or more components of one or more gaming establishment systems operate individually or collectively to enable the user to engage one or more user interfaces, such as an externally-controlled user interface displayed by an EGM, to enter enough information to create (or otherwise access a previously created) gaming establishment account. Once the gaming establishment account is created (or otherwise accessed), such components cause a tracking ticket voucher associated with the created (or otherwise accessed) gaming establishment account to be issued, such as printed by a ticket printer of an EGM. When the tracking ticket voucher is subsequently associated with (e.g., inserted into) one or more gaming devices, such as one or more EGMs, the tracking ticket voucher operates as a user identifier to enable the user be carded in by the system and have their activities occurring at such gaming devices be tracked for benefit accrual purposes. Such a configuration reduces gaming establishment friction in user sign-ups and associated tracking by enabling the gaming establishment to not miss out on opportunities to build user loyalty (when a user has arrived cardless at the gaming establishment) by providing the user with a better experience via rewarding the user for gaming establishment activities, advertising to the user, and/or understanding the user's preferences for current and future interactions. Such a configuration further reduces user friction by decreasing instances when the user, who has arrived cardless at the gaming establishment, is inconvenienced by having to visit a gaming establishment service desk to acquire a new physical user identifier to earn loyalty benefits.

Moreover, by enabling users to still reap the benefits of various gaming establishment systems, such as building loyalty via a patron management system, even when the users do not have any previously provided identifiers of such systems on their person, the present disclosure represents a technological advancement over prior systems that failed to enable access without certain identifiers used as precursors. That is, while prior systems required the appropriate identifier (e.g., without inserting a player tracking card into a card reader of the EGM, no player tracking benefits may be earned for the ensuing gaming session), the system of the present disclosure operates to dynamically create a user identifier (i.e., a tracking ticket voucher) to at least temporarily enable such benefits.

While certain embodiments described below are directed to employing a tracking ticket voucher to identify a user at an EGM (such as, but not limited to, a slot machine, a video poker machine, a video lottery terminal, a terminal associated with an electronic table game, a terminal associated with a live table game, a video keno machine, a video bingo machine and/or a sports betting terminal that offers sports betting opportunities), it should be appreciated that such embodiments may additionally or alternatively be employed in association with identifying a user at any suitable gaming establishment device, such as, but not limited to, a user identification device associated with a gaming table, a ticket voucher redemption kiosk, and/or a retail point-of-sale terminal.

In various embodiments, the system of the present disclosure includes various components or sub-systems operating together to cause one or more ticket vouchers to operate as gaming establishment account identifiers independent of any previously issued identifiers, such as independent of any player tracking cards.

In certain embodiments, the system includes or is in communication with a ticket voucher system. The ticket voucher system includes one or more servers which store, in one or more databases, ticket voucher identification information associated with each ticket voucher created by the ticket voucher system, such as identifying information, value information, and/or activity information. In certain such embodiments, the ticket voucher system maintains ticket voucher data associated with cashless ticket vouchers and tracking ticket vouchers. In certain other embodiments in which, as described below, the system includes or is otherwise in communication with a separate tracking ticket voucher system, the ticket voucher system maintains ticket voucher data associated with cashless ticket vouchers (without maintaining any ticket voucher data associated with any tracking ticket vouchers). In different embodiments, the system utilizes a mobile device running a mobile device application, a ticket voucher kiosk, an interface of a gaming device (e.g., an interface of an EGM or an interface of gaming table component), an externally controlled interface displayed by a gaming device (e.g., a service window displayed by an EGM), a component of a gaming establishment patron management system, such as a player tracking unit, and/or a gaming establishment interface to interface with the ticket voucher system.

In certain embodiments, the system includes or is in communication with a tracking ticket voucher system. In these embodiments, the ticket voucher system includes one or more servers which store, in one or more databases, ticket voucher identification information associated with each tracking ticket voucher created by the tracking ticket voucher system, such as identifying information, and/or activity information. In different embodiments, the system utilizes a mobile device running a mobile device application, a ticket voucher kiosk, an interface of a gaming device (e.g., an interface of an EGM or an interface of gaming table component), an externally controlled interface displayed by a gaming device (e.g., a service window displayed by an EGM), a component of a gaming establishment patron management system, such as a player tracking unit, and/or a gaming establishment interface to interface with the tracking ticket voucher system.

In certain embodiments, in addition to maintaining information associated with each ticket voucher, in certain embodiments in which the ticket voucher takes the form of a paper ticket voucher, the ticket voucher system (and any tracking ticket voucher system) includes one or more ticket voucher system components, such as a ticket voucher printer configured to print paper ticket vouchers. For example, a ticket voucher printer is associated with an EGM that prints ticket vouchers associated with amounts of funds or associated with gaming establishment accounts. In certain other embodiments in which a ticket voucher takes the form of a virtual ticket voucher, the ticket voucher system (and any tracking ticket voucher system) includes one or more interfaces operable to communicate, directly to a mobile device or indirectly to the mobile device, data associated with a virtual ticket voucher associated with an amounts of fund or associated with a gaming establishment account.

In operation of certain embodiments, the system enables the creation of a tracking ticket voucher following an occurrence of a gaming establishment account creation event. In these embodiments, the system causes the issuance of a tracking ticket voucher in association with the creation or opening of a gaming establishment account maintained for a user.

In certain embodiments, the gaming establishment account creation event occurs when a user makes one or more inputs at a gaming establishment device requesting the creation or opening of a gaming establishment account. For example, upon a user at an EGM making one or more inputs via an interface of the EGM (and/or via an externally controlled interface, such as a service window, displayed by the EGM), indicating an intent to create or open a gaming establishment account, the system determines that a gaming establishment account creation event has occurred. In certain embodiments, the gaming establishment account creation event occurs when the system determines that an attempted transaction by a user is not associated with any gaming establishment account and/or the user has indicated that they do not have an open gaming establishment account. In certain embodiments, the gaming establishment account creation event occurs when a user presents picture identification documentation to a gaming establishment device in association with an activity undertaken at the gaming establishment device. For example, upon a user attempting to check into a hotel associated with a gaming establishment by presenting their driver's license to a self-service kiosk, the system determines that the user whom the hotel reservation is under does not have a gaming establishment account and causes a gaming establishment account creation event to occur.

In certain embodiments, the gaming establishment account attempted to be created or opened includes an account associated with a gaming establishment patron management system, such as a player tracking account. In certain embodiments, the gaming establishment account attempted to be created or opened includes an account associated with a gaming establishment fund management system, such as a cashless wagering account operable to hold funds for wagering on games of chance at a gaming device, wagering on games of skill at a gaming device, wagering on the outcomes of sporting events from a gaming device, wagering on gaming of chances remote from a gaming device, wagering on games of skill remote from a gaming device, and/or wagering on the outcomes of sporting events remote from a gaming device. In certain embodiments, the gaming establishment account attempted to be created or opened includes an account associated with a gaming establishment retail system, such as a gaming establishment retail account which holds funds to enable users to purchase goods and/or services at various retail point-of-sale systems throughout a gaming establishment (or located remote from the gaming establishment, but otherwise associated with the gaming establishment).

In certain embodiments, following the occurrence of the gaming establishment account creation event, the system collects certain data from the user which is needed to create the gaming establishment account. In these embodiments, to set up an account with a gaming establishment, certain current jurisdictional regulations require that a user must provide various personal identifying information, such as a name, an address, an email, a phone number and/or a social security number. In certain instances in which the gaming establishment account to be created or opened includes an account associated with a gaming establishment patron management system, such as a player tracking account, the gaming establishment patron management system requires the user to provide all the personal identifying information needed to open the gaming establishment patron management system account. In certain instances in which the gaming establishment account to be created or opened includes an account associated with a gaming establishment patron management system, such as a player tracking account, the gaming establishment patron management system requires the user to provide a minimum amount of personal identifying information (which the gaming establishment patron management system uses to open the account) and subsequently provide additional personal identifying information to complete the account opening. In different embodiments, the type of gaming establishment account to be created determines, at least in part, the type of and/or amount of personal identifying information requested to facilitate the opening of the account.

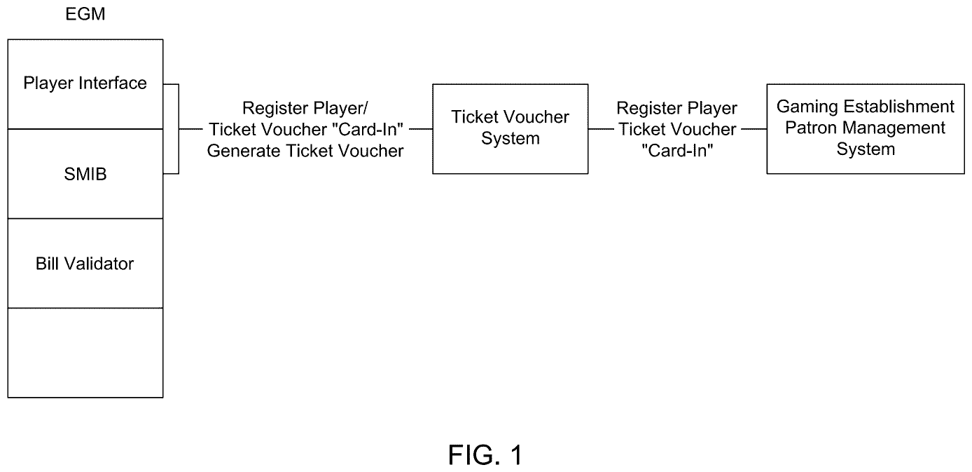

In certain embodiments, the system employs a user interface displayed by a gaming establishment device to collect such personal identifying information. In certain such embodiments, the user interface displayed by the gaming establishment device is controlled separate from the gaming establishment device. For example, as seen in FIG. 1, an EGM displays a player interface which is controlled, via a SMIB of the EGM operating directly with a component of a gaming establishment patron management system (or indirectly with the component of the gaming establishment patron management system via a component of a ticket voucher system) to collect personal identifying information of a user to facilitate the creation of a tracking ticket voucher associated with an account maintained for that user. In certain embodiments, in addition to or alternatively from the user inputting certain personal identifying information via user interface displayed by the gaming establishment device, the user scans a QR code displayed by the user interface of the gaming establishment device. This QR code contains at least a website for the user to navigate to where certain user data is collected in association with the creation of a gaming establishment account.

In certain embodiments, depending on the type of gaming establishment account to be created, the system collects one or more images (or videos) of government issued picture identification documentation, such as a government issued passport or driver's license, presented by the user to one or more image capture devices, such as a camera of a gaming device (e.g., a camera of an EGM), a security camera of a gaming establishment and/or a camera of a mobile device executing a mobile device application associated with the gaming establishment. It should be appreciated that in certain cases, when opening a gaming establishment account, certain operators and/or jurisdictions require that gaming establishment personnel at a gaming establishment service desk verify that the user is in fact the person pictured on the government issued identification that the user presents to the gaming establishment personnel. However, this process is time consuming for the user (whom has to seek out the gaming establishment service desk), potentially unsafe for gaming establishment personnel (whom has to come in close personal contact with dozens of user to review the picture identification documents provided by such user) and suspectable to violation of certain jurisdictional regulations on account of gaming establishment personnel error which may occur if the gaming establishment personnel at a gaming establishment service desk is rushed or otherwise distracted and fails to fully review the presented government issued identification and/or if poor lighting conditions at the gaming establishment service desk hinder the gaming establishment personnel's ability to properly review the government issued identification. As such, by employing the image capture devices to aid in the opening of one or more gaming establishment accounts, these embodiments eliminate the user from having to travel to a gaming establishment service desk to present their picture identification documents to gaming establishment personnel which saves the user time, reduces the amount of foot traffic and associated congestion at the gaming establishment service desk, and potentially keeps gaming establishment personnel out of harms way by removing any direct, in-person interaction with multiple users.

In certain embodiments, following the collection of certain data from the user, the system employs the collected data to create the gaming establishment account. In certain such embodiments, the gaming establishment device that received the data from the user operates with one or more components of one or more systems that maintain the gaming establishment account to cause the creation of the gaming establishment account. In certain embodiments in which the collected data is sufficient to completely create the gaming establishment account, the system proceeds with the creation of the gaming establishment account. In certain embodiments in which the collected data is insufficient to completely create the gaming establishment account, the system proceeds with the partial creation of the gaming establishment account and informs the user that one or more actions are required by the user to complete the creation of the gaming establishment account. In certain such embodiments, when the user enters a minimum amount of data that is insufficient to completely create the gaming establishment account, the system provides an opportunity to perform a minimum validation of the user. For example, when the user enters minimum data of a phone number or an email address, as part of the activation of the gaming establishment account (or as part of creating a ticket voucher associated with the gaming establishment account), the system communicates push notifications to the phone number and/or emails to the email address to verify the existence of the user and also verify the contact information.

In operation of certain other embodiments, the system enables the creation of a tracking ticket voucher following an occurrence of a gaming establishment account access event. In these embodiments, the system causes the issuance of a tracking ticket voucher in association with accessing a previously created or opened gaming establishment account maintained for a user. In certain embodiments, the gaming establishment account access event occurs when a user makes one or more inputs at a gaming establishment device requesting to access a gaming establishment account. For example, upon a user at an EGM making one or more inputs via an interface of the EGM (and/or via an externally controlled interface, such as a service window, displayed by the EGM), indicating the need for a temporary identifier associated with a gaming establishment account (to make up for a lost or forgotten identifier associated with the gaming establishment account), the system determines that a gaming establishment account access event has occurred.

In certain embodiments, following the occurrence of the gaming establishment account access event, the system collects certain data from the user which is needed to access the gaming establishment account. In such embodiments, the system employs a user interface displayed by a gaming establishment device (and controlled by the gaming establishment device or controlled separate from the gaming establishment device) to collect such data. For example, in instances when a user has lost or otherwise misplaced a player tracking card, the system enables the user to engage an EGM displayed interface to input certain identifying information, such as a name and phone number, needed to access the user's player tracking account.

In certain embodiments, following the collection of certain data from the user, the system employs the collected data to access the gaming establishment account. In certain such embodiments, the gaming establishment device that received the data from the user operates with one or more components of one or more systems that maintain the gaming establishment account to cause the retrieval of the gaming establishment account.

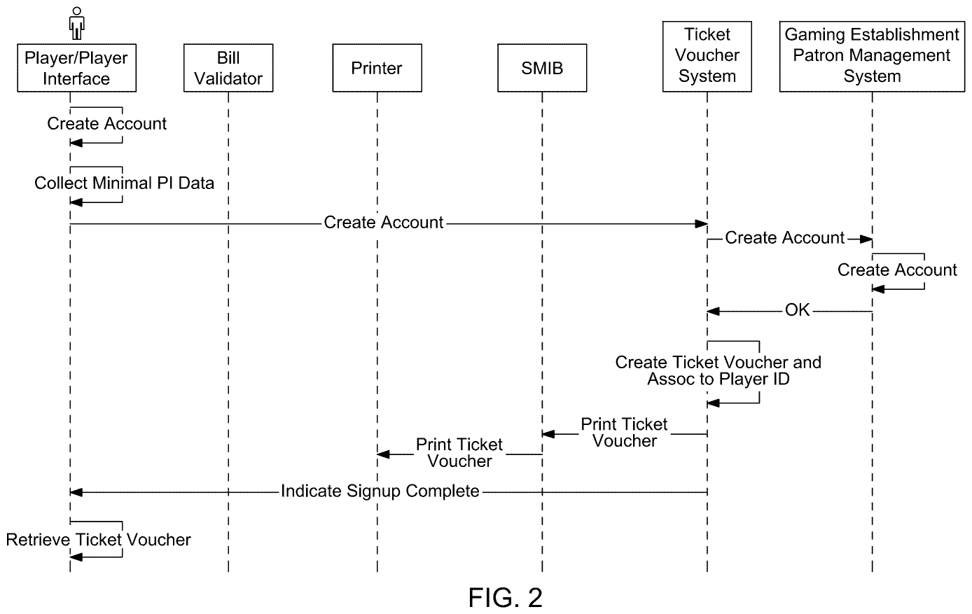

In certain embodiments, following the creation of a gaming establishment account or following the access of a previously created gaming establishment account, the system causes the creation of a tracking ticket voucher associated with the gaming establishment account. In certain such embodiments, a ticket voucher system maintains a mapping between the created ticket voucher and the appropriate gaming establishment account and retains such an association when the gaming establishment account is created (or otherwise accessed). For example, as seen in FIG. 2, when the gaming establishment account includes a gaming establishment patron management system account, such as a player tracking account, the gaming establishment patron management system interfaces with the ticket voucher system to cause the creation of a ticket voucher associated with the created (or accessed) gaming establishment patron management system account. In certain other embodiments, the gaming establishment patron management system maintains a mapping between the created ticket voucher and the appropriate gaming establishment account and retains such an association when the gaming establishment account is created (or otherwise accessed).

Following the creation of the ticket voucher, the system issues the created ticket voucher associated with the gaming establishment account, thereby enabling the created ticket voucher to operate as a temporary account identifier. Continuing with the above example of FIG. 2, the ticket voucher system commands the SMIB of the EGM to cause a printer to print a ticket voucher associated with the created gaming establishment account, such as the created player tracking account, which functions as a temporary player tracking card. In certain other embodiments, the ticket voucher system commands the SMIB of the EGM to instruct the EGM to cause the printer to print a ticket voucher associated with the gaming establishment account. In certain other embodiments, the ticket voucher system commands another system tasked with issuing and maintaining such tracking ticket vouchers to cause a printer associated with that other system to print a ticket voucher associated with the gaming establishment account. In certain other embodiments in which the user scanned a QR code displayed by the user interface of the gaming establishment device, the QR code contained an identification of the gaming establishment device such that once the gaming establishment account is created, the system commands the SMIB associated with the identified gaming establishment device to cause a printer to print a ticket voucher associated with the gaming establishment account. In certain other embodiments in which the tracking ticket voucher takes a virtual form, the ticket voucher system operates to create a virtual ticket voucher associated with the created gaming establishment account, such as the created player tracking account, and communicates, directly or indirectly via one or more of the SMIB of the EGM and/or the EGM, data associated with the created tracking ticket voucher to a mobile device to enable such a tracking ticket voucher to function as a temporary account identifier.

In certain embodiments, since the present disclosure employs a ticket voucher system to maintain such tracking ticket vouchers in addition to cashless ticket vouchers (which are redeemable for cash at a kiosk or to establish a credit balance usable to wager on one or more games of chance at an EGM) and further since certain laws and regulations require that the funds associated with the ticket voucher system be separately maintained and separately reported (to one or more accounting entities, taxation entities, and/or regulatory entities), the issued tracking ticket voucher is associated with identifying information unique to the tracking ticket voucher. That is, by modifying certain information associated with one or more ticket vouchers and/or adding certain information in association with one or more ticket vouchers, the system facilitates the future identification of different types of ticket vouchers. For example, when issuing a cashless ticket voucher, the system employs one or more unique identifiers associated with the cashless ticket voucher which enable the cashless ticket voucher to be subsequently identified and when issuing a tracking ticket voucher, the system employs one or more different unique identifiers associated with the tracking ticket voucher which enable the tracking ticket voucher to be subsequently identified.

In certain embodiments, the ticket voucher system employs part of the ticket voucher number to identify the type of ticket voucher. In these embodiments, since a cashless ticket voucher is associated with ticket voucher identification information maintained by the ticket voucher system to identify that cashless ticket voucher for subsequent validation upon a redemption of that cashless ticket voucher, the system additionally employs different ticket voucher identification information maintained by the ticket voucher system to identify tracking ticket vouchers. In certain such embodiments, a cashless ticket voucher includes an interleaved 2 of 5 barcode which encodes a multi-digit number validation identifier (i.e., the validation ID) that typically begins with “00” and then includes a series of numbers that identify the cashless ticket issuing system, such as an identification code for the gaming establishment which issued the cashless ticket voucher or an identification code for the vendor of the gaming establishment which issued the cashless ticket voucher (to prevent cashless ticket vouchers from being redeemed between different gaming establishments). In these embodiments, the system distinguishes between these cashless ticket vouchers and the created tracking ticket voucher based on the voucher diagraph of the first two digits of the ticket voucher number (i.e., cashless ticket vouchers start with “00” while tracking ticket vouchers start with “11” or any non-00 number). In certain other embodiments, the system reserves a set of ticket voucher identification information maintained by the ticket voucher system, such as a set or range of ticket voucher numbers, to identify the tracking ticket vouchers. In these embodiments, this reserved set of ticket voucher identification information is associated with one or more tracking ticket vouchers and not associated with any cashless ticket vouchers.

In certain embodiments, the system additionally or alternatively employs the prefix and/or suffix of the unique ticket voucher validation number of the ticket voucher to designate additional information to enable that ticket voucher to be subsequently identified and used for its intended purpose. For example, for tracking ticket vouchers, the term “USER ID” is added as a prefix and/or suffix to the unique ticket voucher validation number to aid in an identification of the associated ticket voucher system.

In certain embodiments, the ticket voucher system additionally or alternatively employs non-ticket voucher number information to identify the type of ticket voucher. In certain such embodiments, the database of ticket voucher information maintained by the ticket voucher system assigns a value of $0.00 to any tracking ticket vouchers to designate such ticket vouchers as tracking ticket vouchers.

In certain embodiments, the ticket voucher system additionally or alternatively employs additional ticket type information to identify the type of ticket voucher. In certain such embodiments, when issuing a tracking ticket voucher, the ticket voucher system additionally tracks what ticket vouchers are issued for what purpose. For example, the database of ticket voucher information maintained by the ticket voucher system includes an additional data set that tracks, on a per ticket voucher basis, whether the ticket voucher issued qualifies as a cashless ticket voucher or a tracking ticket voucher.

In certain embodiments, when issuing a tracking ticket voucher, the ticket voucher system additionally or alternatively employs an additional state, such as a User Identifier state, that indicates that the ticket voucher functions as a user identifier. In certain other embodiments, to facilitate the identification of a ticket voucher, the system additionally or alternatively adds additional information to the data presented in the barcode for one or more of the types of ticket vouchers issued. In these embodiments, to facilitate the identification of a ticket voucher, the additional information is accessible via the barcode of one or more of the types of ticket vouchers issued such that upon scanning the barcode of the ticket voucher, the system identifies the type of ticket voucher being redeemed.

In certain embodiments, the system additionally or alternatively employs additional information taking the form of additional images, patterns, barcodes, lines, words and/or numbers which are in addition to the ticket voucher validation number of the ticket voucher and which designate the type of ticket voucher.

In certain embodiments, the system additionally or alternatively removes certain information from one or more types of ticket vouchers to convey an identification of the type of ticket voucher. In these embodiments, the system determines the type of ticket voucher and one or more subsequent actions to undertake based on a lack of certain information of the ticket voucher.

It should thus be appreciated that with multiple types of ticket vouchers maintained for different purposes, the system of certain embodiments provides that, for each cashless ticket voucher, the ticket voucher identification information maintained by the ticket voucher system includes one or more of: a primary key (i.e., an index for the record in the table); a ticket voucher validation number using a first digraph associated with cashless ticket vouchers; a ticket state (e.g., a state of a ticket as being in an issued state or a redeemed state); an issuance date (i.e., the date when the ticket voucher was issued); a property address associated with the ticket voucher issuance; an amount of funds associated with the ticket voucher; any expiration date associated with the ticket voucher; a device identification associated with the issuance of the ticket voucher; an image of the ticket voucher (e.g., an image of a front of the ticket voucher and/or an image of a back of the ticket voucher); a redemption date (i.e., the date the ticket voucher was redeemed at (if the ticket voucher is in the redeemed state; redeemed at (i.e., the device where the ticket voucher was redeemed (if the ticket voucher is in the redeemed state)); and/or a data signature (i.e., a signature of the data associated with the ticket voucher to prevent tampering by casino employees). Additionally, for each tracking ticket voucher, the ticket voucher identification information maintained by the ticket voucher system includes one or more of: a primary key (i.e., an index for the record in the table); a ticket voucher validation number using a second, different digraph associated with tracking ticket vouchers; a ticket state (e.g., a state of being associated with identifying a user); an issuance date (i.e., the date when the ticket voucher was issued); a property address associated with the ticket voucher issuance; a $0.00 amount of funds associated with the ticket voucher; any expiration date associated with the ticket voucher; a device identification associated with the issuance of the ticket voucher; an identity of the gaming establishment account associated with the ticket voucher, an identity of a user associated with the ticket voucher, an image of the ticket voucher (e.g., an image of a front of the ticket voucher and/or an image of a back of the ticket voucher); one or more redemption dates (i.e., the dates the ticket voucher was redeemed at to function as a user identifier, one or more redeemed at locations (i.e., the device where the ticket voucher was redeemed at to function as a user identifier; and/or a data signature (i.e., a signature of the data associated with the ticket voucher to prevent tampering by casino employees).

Accordingly, in certain embodiments, following an occurrence of a tracking ticket voucher creation event at a first electronic gaming machine, a ticket voucher system receives, from a component of a gaming establishment management system, data associated with a gaming establishment account associated with an at least partially identified user. In these embodiments, the ticket voucher system proceeds to create, in a ticket voucher database, an association between ticket voucher data and the gaming establishment account, and cause a ticket voucher associated with the ticket voucher data to be issued. In other words, in certain embodiments, responsive to a cashless ticket voucher creation event, the ticker voucher system creates cashless ticket voucher data associated with an amount of funds, and stores, in a ticket voucher database, a first entry associated with the cashless ticket voucher data. In such embodiments, responsive to a tracking ticket voucher creation event, the ticket voucher system creates tracking ticket voucher data associated with a gaming establishment account, and stores, in the ticket voucher database, a second entry associated with the tracking ticket voucher data.

Moreover, in certain embodiments, an electronic gaming machine receives, via an input device, data to be associated with a player tracking account. In such embodiments, following a creation, by a component of a player tracking system, of the player tracking account, the electronic gaming machines dispenses a tracking ticket voucher. The tracking ticket voucher is maintained by a component of a ticket voucher system independent of the component of the player tracking system, the tracking ticket voucher is associated with the player tracking account and the tracking ticket voucher is redeemable to associate the player tracking account with a gaming session at another electronic gaming machine.

In certain embodiments, following a user procuring a tracking ticket voucher, the system enables the user to redeem the tracking ticket voucher at a gaming establishment device to associate a gaming establishment account with the gaming establishment device. For example, upon a user of an EGM obtaining a tracking ticket voucher as described above, the system enables the user to redeem such a tracking ticket voucher at that EGM (or another EGM) to subsequently identify the user to that EGM (or another EGM).

In certain embodiments in which the ticket voucher being redeemed takes the form of a paper ticket voucher, the user provides the paper ticket voucher to an EGM. In this embodiment, upon receiving the paper ticket voucher, the EGM (or a component of the gaming establishment management system associated with the EGM, such as the SMIB associated with the EGM) scans the paper ticket voucher to obtain identifying information associated with the presented paper ticket voucher. The EGM (or a component of a gaming establishment management system associated with the EGM) then operates with the ticket voucher system to determine the type of ticket voucher being redeemed.

In certain embodiment in which the ticket voucher being redeemed takes the form of a virtual ticket voucher, to redeem the virtual ticket voucher, the user presents a wallet identity (i.e., a mobile device running a mobile device application associated with a virtual ticket voucher) to the EGM. In this embodiment, upon launching the application on the mobile device and following the user selecting a virtual ticket voucher to redeem, the mobile device application prompts the user to cause the mobile device to engage the EGM, such as prompting the user to tap the mobile device to a designated portion of the EGM (or otherwise moving the mobile device to within a designated distance of a designated location of the EGM) to initiate the redemption of the selected virtual ticket voucher. In this embodiment, the EGM (or a component of a gaming establishment management system associated with the EGM) operates with the ticket voucher system to determine the type of ticket voucher being redeemed.

In these embodiments, regardless of the form of the ticket voucher to be redeemed, the EGM, the component of a gaming establishment management system associated with the EGM and/or the ticket voucher system operate individually or collectively to determine the type of ticket voucher attempted to be redeemed. In these embodiments, based on one or more of the differentiating identifiers employed to distinguish between cashless ticket vouchers and tracking ticket vouchers, the system determines the type of the ticket voucher attempted to be redeemed and then proceeds accordingly.

In certain embodiments, the system determines, based on the ticket voucher identifying information of the redeemed ticket voucher, that the ticket voucher being redeemed is a cashless ticket voucher, the ticket voucher system determines whether to authorize the redemption of the ticket voucher. In such instances, the EGM (or a component of a gaming establishment management system associated with the EGM) operates with the ticket voucher system to determine whether the ticket voucher is an authentic ticket voucher currently associated with the amount of funds indicated by the presented ticket voucher. In other words, the system verifies that the presented ticket voucher is a valid ticket voucher which is authentic and has not been previously redeemed and/or voided by the ticket voucher system. If the ticket voucher system determines not to authorize the redemption of the ticket voucher because the ticket voucher is inauthentic or otherwise invalid, such as being previously redeemed or voided by the ticket voucher system, the system communicates a denial to the EGM and does not complete the ticket voucher redemption. If the system determines to authorize the redemption of the ticket voucher because the ticket voucher is valid and authentic, the system notifies the EGM of the approved redemption and operates to increase a credit balance of the EGM based on the amount of funds associated with the ticket voucher and update one or more ticket voucher databases to reflect the redemption of the cashless ticket voucher.

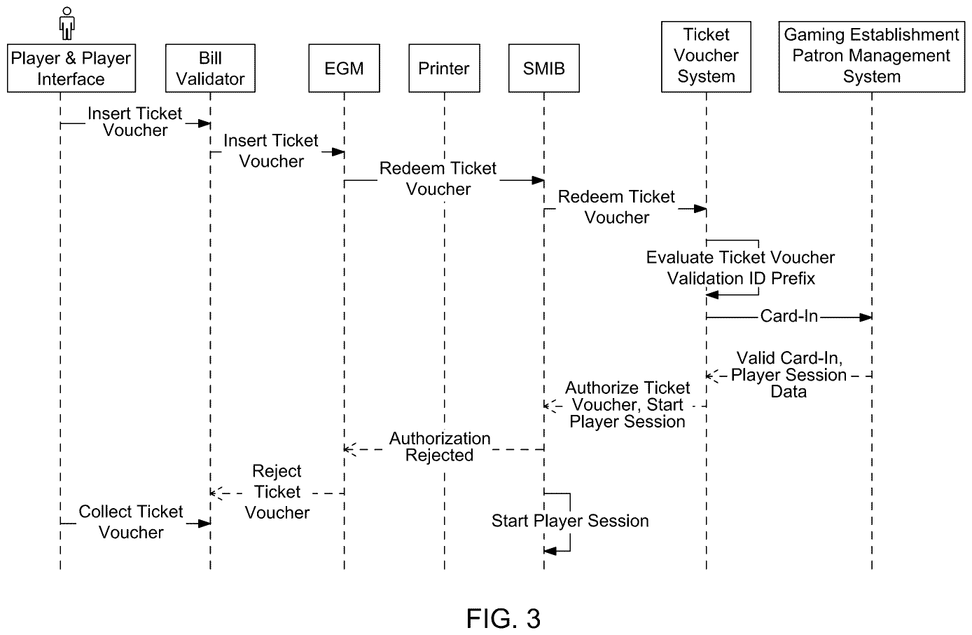

On the other hand, if the system determines, based on the ticket voucher identifying information of the redeemed ticket voucher, that the ticket voucher being redeemed is a tracking ticket voucher, the ticket voucher system operates with zero, one or more components to cause the gaming establishment account associated with the tracking ticket voucher to be associated with the EGM. In certain such embodiments in which the gaming establishment account associated with the tracking ticket voucher is an account of a gaming establishment patron management system, such as a player tracking account, following the ticket voucher system identifying the redeemed ticket voucher as a tracking ticket voucher, the ticket voucher system operates with the gaming establishment patron management system to log the user into the gaming establishment patron management system account, such as the player tracking account, using the redeemed ticket voucher. In these embodiments, once logged in for a session at the EGM, the gaming establishment patron management system (and/or a component of the gaming establishment management patron system associated with the EGM) tracks activities and/or events occurring in association with the session at the EGM to enable the user to potentially earn loyalty benefits from such activities and/or events. For example, as seen in FIG. 3, following a user at an EGM redeeming a ticket voucher, the ticket voucher system determines that the redeemed ticket voucher is a tracking ticket voucher associated with a player tracking account. The ticket voucher system then operates with the player tracking system and the SMIB associated with the EGM to enable the tracking ticket voucher to operate as a player tracking card.

In certain embodiments, since the tracking ticket voucher is a reusable ticket voucher that may be used at multiple different EGMs to log the user into the associated gaming establishment account, following such logging in, the system operates to return the tracking ticket voucher to the user. For example, as further seen in FIG. 3, in addition to employing the tracking ticket voucher as a player tracking card for a session at the EGM, the SMIB operates with the EGM to cause the tracking ticket voucher to be rejected by the bill validator and returned to the user. As such and unlike cashless ticket vouchers which the EGM routes to a ticket voucher receptacle for subsequent collection for accounting, taxation and regulatory purposes, the EGM does not route such tracking ticket vouchers to any ticket voucher receptacles. That is, while the bill validator of the EGM routes received cashless ticket vouchers to a ticket voucher receptacle based on the determined identification of the ticket voucher as a cashless ticket voucher, the bill validator of the EGM returns received tracking ticket vouchers back to the user based on the determined identification of the ticket voucher as a tracking ticket voucher. Put differently, based on one or more of the differentiating identifiers employed to distinguish between cashless ticket vouchers and tracking ticket vouchers, the system additionally determines whether each received ticket voucher warrants being stacked in a ticket voucher receptacle or should remain unstacked for a subsequent return to the user.

Accordingly, in certain embodiments, responsive to a receipt of a first ticket voucher, the electronic gaming machine increases a credit balance based on an amount of funds associated with the first ticket voucher, and retains the first ticket voucher. In these embodiments, responsive to a receipt of a second ticket voucher, the electronic gaming machine associates an electronic gaming machine session with a gaming establishment account associated with the second ticket voucher, and dispenses the receipt of the second ticket voucher without retaining the second ticket voucher.

As such, in certain instances in which a user arrives cardless at a gaming establishment (e.g., without being associated with any player tracking card or without any previously issued player tracking card on their person), one or more components of one or more gaming establishment systems operate individually or collectively to enable the user to engage one or more user interfaces to cause the creation of (or otherwise access to a previously created) gaming establishment account. Once the gaming establishment account is created (or otherwise accessed), such components cause a tracking ticket voucher associated with the created (or otherwise accessed) gaming establishment account to be issued, such as printed by a ticket printer of an EGM. When the tracking ticket voucher is subsequently associated with (e.g., inserted into) one or more gaming devices, such as one or more EGMs, the tracking ticket voucher operates as a user identifier to enable the user be carded in by the system and have their activities occurring at such gaming devices be tracked for benefit accrual purposes. Such a configuration thus reduces gaming establishment friction in user sign-ups and associated tracking by enabling the gaming establishment to not miss out on opportunities to build user loyalty (when a user has arrived cardless at the gaming establishment) by providing the user with a better experience via rewarding the user for gaming establishment activities, advertising to the user, and/or understanding the user's preferences for current and future interactions. Such a configuration further reduces user friction by decreasing instances when the user, who has arrived cardless at the gaming establishment, is inconvenienced by having to visit a gaming establishment service desk to acquire a new physical user identifier to earn loyalty benefits.

Moreover, by enabling users to still reap the benefits of various gaming establishment systems, such as building loyalty via a patron management system, even when the users do not have any previously provided identifiers of such systems on their person, the present disclosure represents a technological advancement over prior systems that failed to enable access without certain identifiers used as precursors. That is, while prior systems required the appropriate identifier (e.g., without inserting a player tracking card into a card reader of the EGM, no player tracking benefits may be earned for the ensuing gaming session), the system of the present disclosure operates to dynamically create a user identifier (i.e., a tracking ticket voucher) to at least temporarily enable such benefits.

It should be appreciated that any functionality or process of the present disclosure may be implemented via one or more servers (associated with or independent of any component of any system disclosed herein), one or more gaming establishment devices (e.g., a gaming device such as an EGM or a non-gaming device such as a point-of-sale terminal), one or more components of a gaming establishment device (such as a component of a gaming establishment management system supported by or otherwise located inside the gaming establishment device), or a mobile device application. For example, while certain data or information of the present disclosure is explained as being communicated from a gaming establishment device (or a component associated with a gaming establishment device) to a mobile device via one or more wireless communication protocols, such data or information may additionally or alternatively be communicated from one or more servers to a mobile device via one or more wireless communication protocols. Accordingly: (i) while certain functions, features or processes are described herein as being performed by a gaming establishment device or a component associated with a gaming establishment device, such functions, features or processes may alternatively be performed by one or more servers, or one or more mobile device applications, or one or more gaming establishment components, (ii) while certain functions, features or processes are described herein as being performed by one or more mobile device applications, such functions, features or processes may alternatively be performed by one or more servers, one or more gaming establishment devices, one or more components of a gaming establishment device, or one or more gaming establishment components, (iii) while certain functions, features or processes are described herein as being performed by one or more servers, such functions, features or processes may alternatively be performed by one or more gaming establishment devices, one or more components of a gaming establishment device, one or more mobile device applications, or one or more gaming establishment components, and (iv) while certain functions, features or processes are described herein as being performed by one or more gaming establishment components, such functions, features or processes may alternatively be performed by one or more gaming establishment devices, one or more components of a gaming establishment device, or one or more servers. As such, in various embodiments, the gaming establishment device employed to utilize a ticket voucher as a user identifier includes: (a) one or more EGMs in combination with one or more servers; (b) one or more personal gaming devices in combination with one or more servers; (c) one or more personal gaming devices in combination with one or more EGMs; (d) one or more personal gaming devices, one or more EGMs, and one or more servers in combination with one another; (e) a single EGM; (f) a plurality of EGMs in combination with one another; (g) a single personal gaming device; (h) a plurality of personal gaming devices in combination with one another; (i) a single server; and/or (j) a plurality of servers in combination with one another. For brevity and clarity and unless specifically stated otherwise, “EGM” as used herein represents one EGM or a plurality of EGMs, “personal gaming device” as used herein represents one personal gaming device or a plurality of personal gaming devices, and “server” as used herein represents one server or a plurality of servers.

As noted above, in various embodiments, the gaming device comprises an EGM (or personal gaming device) in combination with a server. In such embodiments, the EGM (or personal gaming device) is configured to communicate with the server through a data network or remote communication link. In certain such embodiments, the EGM (or personal gaming device) is configured to communicate with another EGM (or personal gaming device) through the same data network or remote communication link or through a different data network or remote communication link. For example, a gaming establishment includes a plurality of EGMs that are each configured to communicate with a server through a data network.

In certain embodiments in which the gaming device comprises an EGM (or personal gaming device) in combination with a server, the server is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the server. The at least one processor of that EGM (or personal gaming device) is configured to execute the events, messages, or commands represented by such data or signals in conjunction with the operation of the EGM (or personal gaming device). Moreover, the at least one processor of the server is configured to transmit and receive data or signals representing events, messages, commands, or any other suitable information between the server and the EGM (or personal gaming device). The at least one processor of the server is configured to execute the events, messages, or commands represented by such data or signals in conjunction with the operation of the server. One, more than one, or each of the functions of the server may be performed by the at least one processor of the EGM (or personal gaming device). Further, one, more than one, or each of the functions of the at least one processor of the EGM (or personal gaming device) may be performed by the at least one processor of the server.

In certain such embodiments, computerized instructions for controlling any games (such as any primary or base games and/or any secondary or bonus games) displayed by the EGM (or personal gaming device) are executed by the server. In such “thin client” embodiments, the server remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the server to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which a gaming establishment includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming establishment includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming device includes an EGM (or personal gaming device) and a server, computerized instructions for controlling any primary or base games displayed by the EGM (or personal gaming device) are communicated from the server to the EGM (or personal gaming device) in a thick client configuration, and computerized instructions for controlling any secondary or bonus games or other functions displayed by the EGM (or personal gaming device) are executed by the server in a thin client configuration.

In certain embodiments in which the gaming establishment includes: (a) an EGM (or personal gaming device) configured to communicate with a server through a data network; and/or (b) a plurality of EGMs (or personal gaming devices) configured to communicate with one another through a data network, the data network is a local area network (LAN) in which the EGMs (or personal gaming devices) are located substantially proximate to one another and/or the server. In one example, the EGMs (or personal gaming devices) and the server are located in a gaming establishment or a portion of a gaming establishment.

In other embodiments in which the gaming device includes: (a) an EGM (or personal gaming device) configured to communicate with a server through a data network; and/or (b) a plurality of EGMs (or personal gaming devices) configured to communicate with one another through a data network, the data network is a wide area network (WAN) in which one or more of the EGMs (or personal gaming devices) are not necessarily located substantially proximate to another one of the EGMs (or personal gaming devices) and/or the server. For example, one or more of the EGMs (or personal gaming devices) are located: (a) in an area of a gaming establishment different from an area of the gaming establishment in which the server is located; or (b) in a gaming establishment different from the gaming establishment in which the server is located. In another example, the server is not located within a gaming establishment in which the EGMs (or personal gaming devices) are located. In certain embodiments in which the data network is a WAN, the gaming device includes a server and an EGM (or personal gaming device) each located in a different gaming establishment in a same geographic area, such as a same city or a same state. Gaming devices in which the data network is a WAN are substantially identical to gaming devices in which the data network is a LAN, though the quantity of EGMs (or personal gaming devices) in different gaming establishments may vary relative to one another.

In certain embodiments, the above-described embodiments of the present disclosure may be implemented in accordance with or in conjunction with zero, one or more components of a ticket voucher system; zero, one or more components of a gaming establishment patron management system and/or zero, one or more gaming establishment devices. In these embodiments, such components of the ticket voucher system, the gaming establishment patron management system and/or the gaming establishment device each include a controller including at least one processor.

The at least one processor is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or fund information) via a communication interface of the controller; (2) converting signals read by an interface to a format corresponding to that used by software or memory of the component of the ticket voucher system, the component of the gaming establishment patron management system and/or the gaming establishment device; (3) accessing memory to configure or reconfigure parameters in the memory according to indicia read from the component of the ticket voucher system, the component of the gaming establishment patron management system and/or the gaming establishment device; (4) communicating with interfaces and the peripheral devices (such as input/output devices); and/or (5) controlling the peripheral devices. In certain embodiments, one or more components of the controller (such as the at least one processor) reside within a housing of the component of the ticket voucher system, the component of the gaming establishment patron management system and/or the gaming establishment device, while in other embodiments, at least one component of the controller resides outside of the housing of the component of the ticket voucher system, the component of the gaming establishment patron management system and/or the gaming establishment device.

The controller also includes at least one memory device, which includes: (1) volatile memory (e.g., RAM which can include non-volatile RAM, magnetic RAM, ferroelectric RAM, and any other suitable forms); (2) non-volatile memory (e.g., disk memory, FLASH memory, EPROMs, EEPROMs, memristor-based non-volatile solid-state memory, etc.); (3) unalterable memory (e.g., EPROMs); (4) read-only memory; and/or (5) a secondary memory storage device, such as a non-volatile memory device, configured to store software related information (the software related information and the memory may be used to store various files not currently being used and invoked in a configuration or reconfiguration). Any other suitable magnetic, optical, and/or semiconductor memory may operate in conjunction with the component of the ticket voucher system, the component of the gaming establishment patron management system and/or the gaming establishment device disclosed herein. In certain embodiments, the at least one memory device resides within the housing of the component of the ticket voucher system, the component of the gaming establishment patron management system and/or the gaming establishment device, while in other embodiments at least one component of the at least one memory device resides outside of the housing of the component of the ticket voucher system, the component of the gaming establishment patron management system and/or the gaming establishment device. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device is configured to store, for example: (1) configuration software, such as all the parameters and settings on the component of the ticket voucher system, the component of the gaming establishment patron management system and/or the gaming establishment device; (2) associations between configuration indicia read from the component of the ticket voucher system, the component of the gaming establishment patron management system and/or the gaming establishment device with one or more parameters and settings; (3) communication protocols configured to enable the at least one processor to communicate with the peripheral devices; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the component of the ticket voucher system, the component of the gaming establishment patron management system and/or the gaming establishment device to communicate with local and non-local devices using such protocols. In one implementation, the controller communicates with other devices using a serial communication protocol. A few non-limiting examples of serial communication protocols that other devices, such as peripherals (e.g., a bill validator or a ticket printer), may use to communicate with the controller include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device is configured to store program code and instructions executable by the at least one processor of the component of the ticket voucher system, the component of the gaming establishment patron management system and/or the gaming establishment device to control the component of the ticket voucher system, the component of the gaming establishment patron management system and/or the gaming establishment device. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a retail patron uses such a removable memory device in a component of the gaming establishment fund management system to implement at least part of the present disclosure. In other embodiments, part or all of the program code and/or the operating data is downloaded to the at least one memory device of the component of the ticket voucher system, the component of the gaming establishment patron management system and/or the gaming establishment device through any suitable data network described above (such as an Internet or intranet).

The at least one memory device also stores a plurality of device drivers. Examples of different types of device drivers include device drivers for the component of the ticket voucher system, the component of the gaming establishment patron management system and/or the gaming establishment device and device drivers for the peripheral components. Typically, the device drivers utilize various communication protocols that enable communication with a particular physical device. The device driver abstracts the hardware implementation of that device. For example, a device driver may be written for each type of card reader that could potentially be connected to the component of the ticket voucher system, the component of the gaming establishment patron management system and/or the gaming establishment device. Non-limiting examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the component of the ticket voucher system, the component of the gaming establishment patron management system and/or the gaming establishment device loads the new device driver from the at least one memory device to enable communication with the new device. For instance, one type of card reader in the component of the ticket voucher system, the component of the gaming establishment patron management system and/or the gaming establishment device can be replaced with a second different type of card reader when device drivers for both card readers are stored in the at least one memory device.

In certain embodiments, the software units stored in the at least one memory device can be upgraded as needed. For instance, when the at least one memory device is a hard drive, new parameters, new settings for existing parameters, new settings for new parameters, new device drivers, and new communication protocols can be uploaded to the at least one memory device from the controller or from some other external device. As another example, when the at least one memory device includes a CD/DVD drive including a CD/DVD configured to store options, parameters, and settings, the software stored in the at least one memory device can be upgraded by replacing a first CD/DVD with a second CD/DVD. In yet another example, when the at least one memory device uses flash memory or EPROM units configured to store options, parameters, and settings, the software stored in the flash and/or EPROM memory units can be upgraded by replacing one or more memory units with new memory units that include the upgraded software. In another embodiment, one or more of the memory devices, such as the hard drive, may be employed in a software download process from a remote software server.

In some embodiments, the at least one memory device also stores authentication and/or validation components configured to authenticate/validate specified components of the component of the ticket voucher system, the component of the gaming establishment patron management system and/or the gaming establishment device and/or information, such as hardware components, software components, firmware components, peripheral device components, user input device components, information received from one or more user input devices, information stored in the at least one memory device, etc.

In certain embodiments, the peripheral devices include several device interfaces, such as, but not limited to: (1) at least one output device including at least one display device; (2) at least one input device (which may include contact and/or non-contact interfaces); (3) at least one transponder; (4) at least one wireless communication component; (5) at least one wired/wireless power distribution component; (6) at least one sensor; (7) at least one data preservation component; (8) at least one motion/gesture analysis and interpretation component; (9) at least one motion detection component; (10) at least one portable power source; (11) at least one geolocation module; (12) at least one user identification module; (13) at least one user/device tracking module; and (14) at least one information filtering module.

In certain embodiments in which the gaming device includes an EGM, the at least one output device includes at least one display device configured to display any game(s) displayed by the EGM and any suitable information associated with such game(s). In certain embodiments, the display devices are connected to or mounted on a housing of the EGM (described below). In various embodiments, the display devices serve as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touchscreen with an associated touch-screen controller. The display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments in which the gaming device includes an EGM, the at least one output device includes a payout device. In these embodiments, after the EGM receives an actuation of a cashout device (described below), the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player. While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments in which the gaming device includes an EGM, the at least one output device is a sound generating device controlled by one or more sound cards. In one such embodiment, the sound generating device includes one or more speakers or other sound generating hardware and/or software configured to generate sounds, such as by playing music for any games or by playing music for other modes of the EGM, such as an attract mode. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

The at least one input device may include any suitable device that enables an input signal to be produced and received by the at least one processor. In one embodiment in which the gaming device includes an EGM, the at least one input device includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. In another embodiment in which the gaming device includes an EGM, the at least one input device includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. When the EGM is funded, the at least one processor determines the amount of funds entered and displays the corresponding amount on a credit display or any other suitable display as described below.

In certain embodiments in which the gaming device includes an EGM, the at least one input device includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously placed wager on a play of a game. A further such wagering or betting device is a bet one device that, when actuated, causes the EGM to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments in which the gaming device includes an EGM, the at least one input device includes at least one game play activation device. In various embodiments, the one or more game play initiation devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game.

In other embodiments in which the gaming device includes an EGM, the at least one input device includes a cashout device. In various embodiments, the cashout device is: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). When the EGM receives an actuation of the cashout device from a player and the player has a positive (i.e., greater-than-zero) credit balance, the EGM initiates a payout associated with the player's credit balance.

In certain embodiments, the at least one input device includes a touchscreen coupled to a touch-screen controller or other touch-sensitive display overlay to enable interaction with any images displayed on a display device (as described below). One such input device is a conventional touch-screen button panel. The touchscreen and the touch-screen controller are connected to a video controller. In these embodiments, signals are input by touching the touch screen at the appropriate locations. The at least one wireless communication component includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component transmits electrical, electromagnetic, or optical signals that carry digital data streams or analog signals representing various types of information.

In certain embodiments, the at least one wired/wireless power distribution component includes components or devices that are configured to provide power to other devices. For example, in one embodiment, the at least one power distribution component includes a magnetic induction system that is configured to provide wireless power to one or more user input devices near the EGM. In one embodiment, a user input device docking region is provided, and includes a power distribution component that is configured to recharge a user input device without requiring metal-to-metal contact. In one embodiment, the at least one power distribution component is configured to distribute power to one or more internal components of the EGM, such as one or more rechargeable power sources (e.g., rechargeable batteries) located at the EGM.

In certain embodiments, the at least one sensor includes at least one of: optical sensors, pressure sensors, RF sensors, infrared sensors, image sensors, thermal sensors, and biometric sensors. The at least one sensor may be used for a variety of functions, such as: detecting movements and/or gestures of various objects within a predetermined proximity to the EGM; detecting the presence and/or identity of various persons (e.g., players, casino employees, etc.), devices (e.g., user input devices), and/or systems within a predetermined proximity to the EGM.

In certain embodiments, the at least one data preservation component is configured to detect or sense one or more events and/or conditions that, for example, may result in damage to the EGM and/or that may result in loss of information associated with the EGM. Additionally, the data preservation system 1062 may be operable to initiate one or more appropriate action(s) in response to the detection of such events/conditions.

In certain embodiments, the at least one motion/gesture analysis and interpretation component 1064 is configured to analyze and/or interpret information relating to detected player movements and/or gestures to determine appropriate player input information relating to the detected player movements and/or gestures. For example, in one embodiment, the at least one motion/gesture analysis and interpretation component is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

In certain embodiments, the at least one geolocation module is configured to acquire geolocation information from one or more remote sources and use the acquired geolocation information to determine information relating to a relative and/or absolute position. For example, in one implementation, the at least one geolocation module is configured to receive GPS signal information for use in determining the position or location of the EGM. In another implementation, the at least one geolocation module is configured to receive multiple wireless signals from multiple remote devices (e.g., EGMs, servers, wireless access points, etc.) and use the signal information to compute position/location information relating to the position or location of the EGM.

In certain embodiments, the at least one user identification module is configured to determine the identity of the current user. For example, in one embodiment, the current user is required to perform a login process at the EGM in order to access one or more features. Alternatively, the EGM is configured to automatically determine the identity of the current user based on one or more external signals, such as an RFID tag or badge worn by the current user and that provides a wireless signal to the EGM that is used to determine the identity of the current user. In at least one embodiment, various security features are incorporated into the EGM to prevent unauthorized users from accessing confidential or sensitive information.

In various embodiments, the component of the ticket voucher system, the component of the gaming establishment patron management system and/or the gaming establishment device includes a plurality of communication ports configured to enable the at least one processor of the component of the ticket voucher system, the component of the gaming establishment patron management system and/or the gaming establishment device to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

It should be appreciated that certain of the gaming devices described herein, such as EGMs located in a casino or another gaming establishment, include certain components and/or are configured to operate in certain manners that differentiate these systems from any general-purpose computing devices. For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general-purpose computing devices. For purposes of illustration, a description of EGMs relative to general-purpose computing devices and some examples of these additional (or different) hardware and/or software architectures found in EGMs are described below.

At first glance, one might think that adapting general-purpose computing device technologies to the gaming industry and EGMs would be a simple proposition because both general-purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general-purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general-purpose computing devices and EGMs are described below. A first difference between EGMs and general-purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General-purpose computing devices are not state-based machines, and a majority of data is usually lost when a malfunction occurs on a general-purpose computing device.

A second difference between EGMs and general-purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulator in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general-purpose computing devices (and as described in more detail above) is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general-purpose computing devices is that EGMs have unique peripheral device requirements that differ from those of a general-purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general-purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general-purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third-party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general-purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. As such, these changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor following an occurrence of a tracking ticket voucher creation event at a first electronic gaming machine, cause the processor to:
receive, from a component of a gaming establishment management system, data associated with a gaming establishment account associated with an at least partially identified user,
create, in a ticket voucher database, an association between ticket voucher data and the gaming establishment account, and
cause a ticket voucher associated with the ticket voucher data to be issued.

2. The system of claim 1, wherein the gaming establishment management system comprises a player tracking system and the gaming establishment account comprises a player tracking account.

3. The system of claim 1, wherein the gaming establishment management system comprises a cashless wagering system and the gaming establishment account comprises a cashless wagering account.

4. The system of claim 1, wherein the issued ticket voucher is redeemable at a second electronic gaming machine to log the at least partially identified user into created gaming establishment account from the second electronic gaming machine.

5. The system of claim 4, wherein the first electronic gaming machine is different from the second electronic gaming machine.

6. The system of claim 1, wherein the issued ticket voucher comprises a printed ticket voucher.

7. The system of claim 1, wherein the association between ticket voucher data and the gaming establishment account is based on a ticket voucher identification number reserved for ticket vouchers associated with gaming establishment accounts.

8. The system of claim 1, wherein the association between ticket voucher data and the gaming establishment account is based on a ticket voucher state dedicated to ticket vouchers associated with gaming establishment accounts.

9. The system of claim 1, wherein the association between ticket voucher data and the gaming establishment account is based on no amount of funds being associated with the ticket voucher.

10. An electronic gaming machine comprising:
a processor; and
a memory device that stores a plurality of instructions that, when executed by the processor, cause the processor to:
receive, via an input device, data to be associated with a player tracking account, and
following a creation, by a component of a player tracking system, of the player tracking account, dispense a tracking ticket voucher, wherein the tracking ticket voucher is maintained by a component of a ticket voucher system independent of the component of the player tracking system, the tracking ticket voucher is associated with the player tracking account and the tracking ticket voucher is redeemable to associate the player tracking account with a gaming session at another electronic gaming machine.

11. The electronic gaming machine of claim 10, wherein dispensing the tracking ticket voucher occurs in association with a slot machine interface board commanding a printer of the electronic gaming machine to print the tracking ticket voucher.

12. A method of operating a system, the method comprising:
following an occurrence of a tracking ticket voucher creation event at a first electronic gaming machine:
receiving, from a component of a gaming establishment management system, data associated with a gaming establishment account associated with an at least partially identified user,
creating, by a processor and in a ticket voucher database, an association between ticket voucher data and the gaming establishment account, and
causing, by the processor, a ticket voucher associated with the ticket voucher data to be issued.

13. The method of claim 12, wherein the gaming establishment management system comprises a player tracking system and the gaming establishment account comprises a player tracking account.

14. The method of claim 12, wherein the gaming establishment management system comprises a cashless wagering system and the gaming establishment account comprises a cashless wagering account.

15. The method of claim 12, wherein the issued ticket voucher is redeemable at a second electronic gaming machine to log the at least partially identified user into created gaming establishment account from the second electronic gaming machine.

16. The method of claim 15, wherein the first electronic gaming machine is different from the second electronic gaming machine.

17. The method of claim 12, wherein the issued ticket voucher comprises a printed ticket voucher.

18. The method of claim 12, wherein the association between ticket voucher data and the gaming establishment account is based on a ticket voucher identification number reserved for ticket vouchers associated with gaming establishment accounts.

19. The method of claim 12, wherein the association between ticket voucher data and the gaming establishment account is based on a ticket voucher state dedicated to ticket vouchers associated with gaming establishment accounts.

20. The method of claim 12, wherein the association between ticket voucher data and the gaming establishment account is based on no amount of funds being associated with the ticket voucher.
